(19) United States
(12) Patent Application Publication
(10) Pub. No.: US 2019/0343318 A1
(43) Pub. Date: Nov. 14, 2019

(54) CURTAIN CONTROLLER ASSEMBLY STRUCTURE

(71) Applicant: CHEN TIAN CO., LTD., Tainan City (TW)

(72) Inventor: CHING-HSIANG CHENG, TAINAN CITY (TW)

(21) Appl. No.: 15/978,316

(22) Filed: May 14, 2018

(51) Int. Cl. A47H 5/02; E06B 9/322; E06B 9/42; E06B 9/78

(52) U.S. Cl. CPC A47H 5/02; E06B 9/322; E06B 2009/785; E06B 9/78; E06B 2009/425; E06B 9/42

(57) ABSTRACT

A curtain controller assembly structure is disclosed herein. It comprises a bead chain seat having a first chamber, a plurality of first engaging portions disposed at an opening of the first chamber, and a plurality of first engaging parts on a wall of the first chamber; an assembly lid disposed in the first chamber of the bead chain seat and having a basal part, wherein the basal part has a plurality of second engaging parts on a lateral thereof for respectively engaging with the first chamber and the plurality of first engaging parts for positioning; and a cover having a second chamber and a plurality of second engaging portions disposed on a wall of an opening of the second chamber for respectively engaging with the plurality of first engaging portions of the bead chain seat.

### BACKGROUND OF THE INVENTION

1. Field of the Invention

The present invention relates to a curtain controller assembly structure which does not need screws to lock and can be assembled automatically so as to increase production capacity and reduce labor costs.

### 2. Description of Related Art

Generally, a curtain controller (9) of a prior art as shown in FIG. 5 comprises a bead chain seat (91), a driving assembly (92), an assembling seat (93), a braking assembly (94), a first driving unit (95), a rectangular driving shaft (96), a seal cap (97), a second driving unit (98), and a cover (99). The bead chain seat (91) is provided with an accommodating slot (911), a plurality of first locking holes (912) on a side surface of an opening of the accommodating slot (911), and a bead chain disc (913) having one end for correspondingly connecting the opening of the accommodating slot (911). The driving assembly (92) is accommodated in the accommodating slot (911) for connecting the bead chain disc (913) of the bead chain seat (91) and provided with a driving unit (921). The assembling seat (93) is provided with a chamber (931), a plurality of second locking holes (932) at a bottom of the chamber (931) and corresponding to the plurality of first locking holes (912) of the bead chain seat (91), a plurality of third locking holes (933) disposed at an opening of the chamber (931), and a plurality of first screws (934) to respectively inserting into the plurality of first locking holes (912) and the plurality of second locking holes (932). The braking assembly (94) and the first driving unit (95) are sequentially accommodated in the chamber (931) of the assembling seat (93). The braking assembly (94) is provided with a braking cylinder (941) and a rectangular perforation (942) at a center of the braking cylinder (941). One end of the rectangular driving shaft (96) is inserted into the rectangular perforation (942, and the other end of the rectangular driving shaft (96) is inserted into the driving unit (921) of the driving assembly (92). The seal cap (97) is covered at the opening of the chamber (931) of the assembling seat (93) and provided with a plurality of fourth locking holes (971) on a periphery thereof and corresponding to the plurality of third locking holes (933). The second driving unit (98) is disposed on the seal cap (97) for connecting the first driving unit (95) and accommodated in the cover (99). The cover (99) is provided with a plurality of fifth locking holes (991) on a periphery thereof corresponding to the plurality of fourth locking holes (971) of the seal cap (97) and a plurality of second screws (992) for inserting into the plurality of fifth locking holes (991), the fourth locking holes (971) and the third locking holes (933) for fixation and connection of the cover (99), the seal cap (97), and the assembling seat (93).

It can be learned that the aforementioned curtain controller structure secures the driving assembly (92) in the accommodating slot (911) of the bead chain seat (91) by screwing the first screws (934) to the first locking holes (912) of the bead chain seat (91) and the second locking holes (932) of the assembling seat (93), and then secures the assembly of the braking assembly (94), the first driving unit (95) and the second driving unit (98) by screwing the second screws (992) to the cover (99), the seal cap (97) and the assembling seat (93). In such a case, it is necessary to manually align the locking holes (912) (932) (991) (971) of the bead chain seat (91), the assembling seat (93), the cover (99), and the seal cap (97), and then manually screw the screws (934) (992) to the locking holes (912) (932) (991) (971), so the conventional structure has many disadvantages, e.g. high cost of the screws, high manpower consumption, and inability to automate production, resulting in slow production efficiency and unstable product quality.

Furthermore, the bead chain disc (913) of the conventional structure is driven by the driving assembly (92) through the rectangular driving shaft (96) to rotate the braking assembly (94), and the braking assembly (94) is further driven by the first driving unit (95) and the second driving unit (98) to rotate a roller rod and control the curtain to vertically or horizontally shrink or extend. Because the rectangular driving shaft (96) and the braking cylinder (941) are separate elements, an aperture tolerance of the rectangular perforation (942) on the braking cylinder (941) must be larger than a diameter of the rectangular driving shaft (96) to allow the assembly of the rectangular driving shaft (96) to the rectangular perforation (942). In such a case, there is a gap between the rectangular perforation (942) and the rectangular driving shaft (96).

When the braking cylinder (941) is driven by the rectangular driving shaft (96) to rotate, the rectangular driving shaft (96) first contacts the rectangular perforation (942) on the plastic braking cylinder (941) and then drives the braking cylinder (941) to rotate, so the diameter of the rectangular perforation (942) is easily enlarged due to an abrasion for a period of time by the rectangular driving shaft (96), and such phenomenon will be more obvious as the weight of the curtain increases. As a result, when the user pulls the bead chain string to actuate the bead chain disc (913), the braking assembly (94) driven by the driving assembly (92) and the rectangular driving shaft (96) may not rotate smoothly, and the rectangular driving shaft (96) and the braking cylinder (941) may even have idle rotation, resulting in failure to drive the curtain to shrink or extend.

### SUMMARY OF THE INVENTION

Therefore, in view of the above-mentioned problems, the object of the present invention is to provide a curtain controller assembly structure which does not need screws to lock and can be assembled automatically so as to increase production capacity and reduce labor costs.

Disclosed herein is a curtain controller assembly structure. It mainly comprises a bead chain seat and an assembly lid. The bead chain seat has a first chamber and a plurality of first engaging parts on a wall of the first chamber. The first chamber is provided with a step edge on the wall thereof and adjacent to the plurality of first engaging parts. The assembly lid has a basal part accommodated in the first chamber of the bead chain seat and is located between the plurality of first engaging parts and the step edge. The basal part has a first side surface for contacting the step edge of the first chamber, a second side surface, and a plurality of second engaging parts disposed on a lateral thereof for respectively engaging with the plurality of first engaging parts of the first chamber for positioning.

According to an embodiment of the present invention, each of the plurality of first engaging parts of the bead chain seat is formed as a tenon, and each of the plurality of second engaging parts of the assembly lid is formed as a locking slot disposed at the lateral of the second side surface of the basal part for engaging with each of the plurality of first engaging parts for positioning.

According to an embodiment of the present invention, each of the plurality of first engaging parts of the bead chain seat is provided with a support surface for contacting bottoms of the plurality of second engaging parts of the basal part for positioning and a guiding incline opposite to the support surface, and the lateral of the first side surface of the basal part of the assembly lid is provided with a plurality of guide trenches corresponding to the plurality of first engaging parts for mutually guiding the basal part of the assembly lid insert into the bead chain seat and locate between the plurality of first engaging parts and the step edge.

According to an embodiment of the present invention, the bead chain seat is provided with a plurality of first engaging portions at an opening of the first chamber and connected with a cover having a second chamber for correspondingly connecting the opening of the first chamber of the bead chain seat and a plurality of second engaging portions on a wall of an opening of the second chamber for correspondingly engaging with the plurality of first engaging portions of the bead chain seat.

According to an embodiment of the present invention, each of the plurality of first engaging portions of the bead chain seat is formed as an inserting slice having a dovetail shape, and each of the plurality of second engaging portions of the cover is formed as an engaging slot having a dovetail shape for correspondingly engaging with the inserting slice of the bead chain seat.

According to an embodiment of the present invention, each of the plurality of first engaging portions of the bead chain seat and each of the plurality of second engaging portions of the cover are respectively provided with a first inserting hole and a second inserting hole corresponding to the first inserting hole for an insertion of a pin.

According to an embodiment of the present invention, a braking assembly is further provided and comprises a braking cylinder and a driving shaft having one end integrally wrapped and injected with the braking cylinder. The braking cylinder is provided with an inner space, and a center of the second side surface of the basal part of the assembly lid is provided with a joint section for inserting in the inner space of the braking cylinder and having a through hole at a center thereof for an insertion of the other end of the driving shaft.

In assembly of the curtain controller assembly structure of the present invention, all elements can be assembled and positioned by engaging the first engaging parts of the bead chain seat with the second engaging parts of the assembly lid and engaging the first engaging portion of the bead chain seat with the second engaging portions of the cover. Accordingly, the present invention saves the cost of using a screw for locking and can be assembled automatically due to the single assembly direction so as to achieve effects, e.g. automated production, increased production capacity, reduced labor costs, and stable product quality.

### BRIEF DESCRIPTION OF THE DRAWINGS

FIG. 1 is an explosion diagram showing a curtain controller assembly structure according to the present invention;

FIG. 2 is a stereogram showing a bead chain seat according to the present invention;

FIG. 3 is a stereogram showing a curtain controller assembly structure in assembly according to the present invention;

FIG. 4 is a cross-sectional view showing a curtain controller assembly structure in assembly according to the present invention;

FIG. 5 is an explosion diagram showing a curtain controller of a prior art.

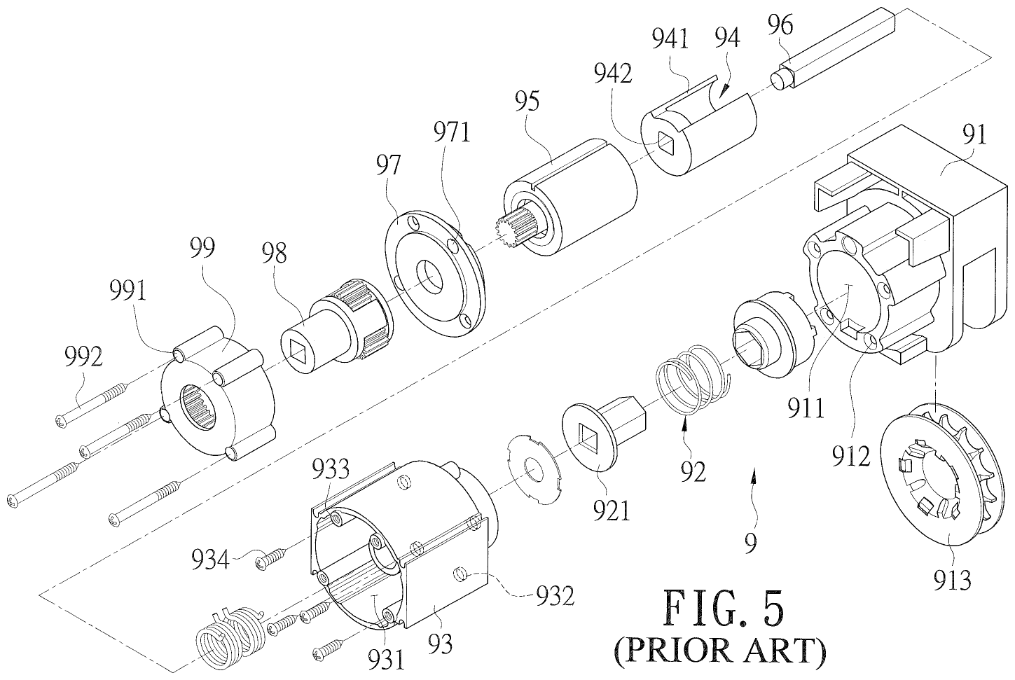

### DETAILED DESCRIPTION OF THE PREFERRED EMBODIMENT

Hereinafter, an exemplary embodiment of the present invention will be described in detail with reference to the accompanying drawings.

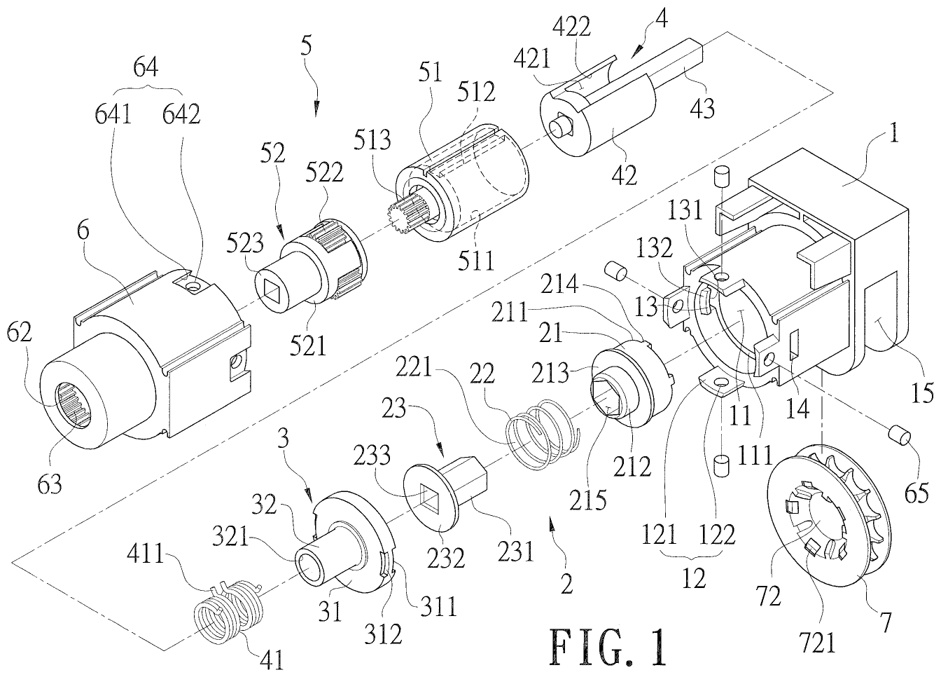

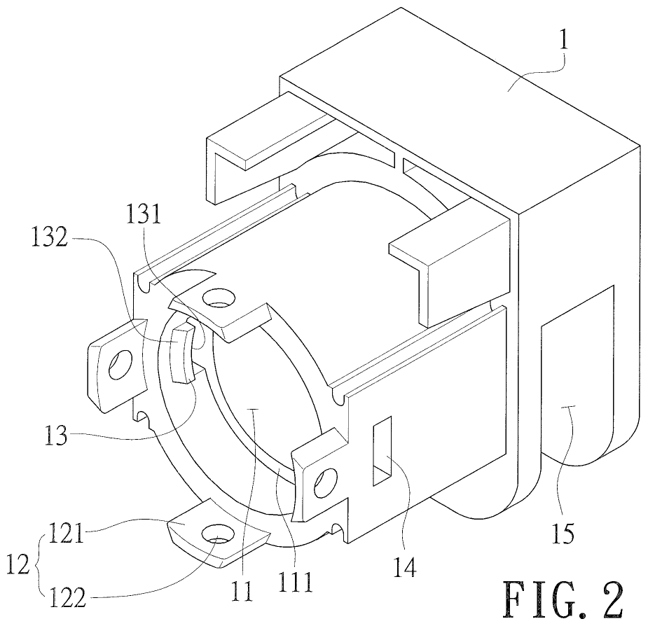

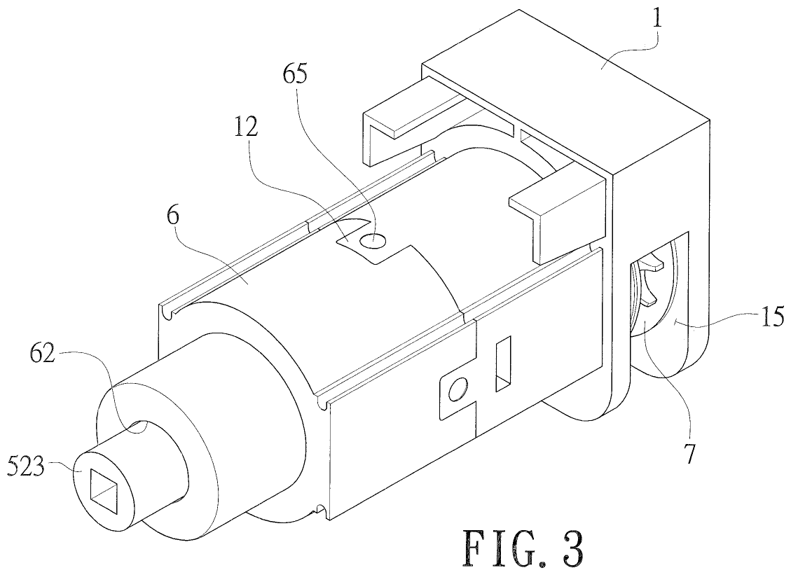

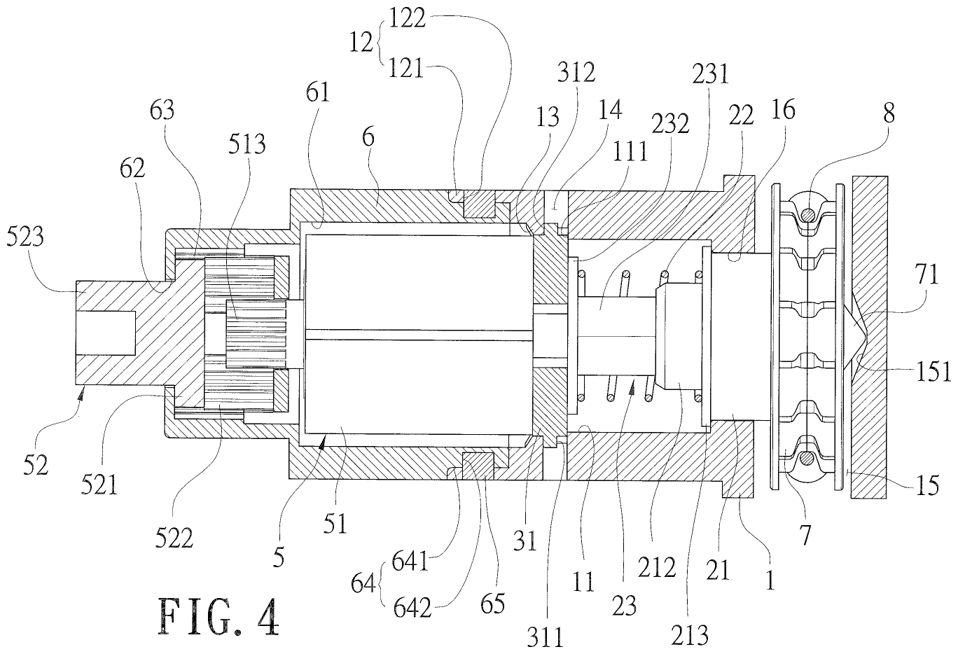

Referring to FIG. 1 to FIG. 4, a curtain controller assembly structure is disclosed herein. It mainly comprises a bead chain seat (1), a first driving assembly (2), an assembly lid (3), a braking assembly (4), a second driving assembly (5), a cover (6), and a bead chain disc (7).

The bead chain seat (1) is provided with a first end, a second end opposite to the first end, a first chamber (11) having an opening at the first end of the bead chain seat (1) and a step edge (111) on a wall of the first chamber (11), a plurality of first engaging portions (12) at the first end of the bead chain seat (1), a plurality of first engaging parts (13) on a wall of the first chamber (11) and adjacent to step edge (111) of the first chamber (11), a plurality of mold release holes (14) respectively disposed between the step edge (111) of the first chamber (11)and each of the plurality of first engaging parts (13), an accommodation space (15) disposed at the second end of the bead chain seat (1), and an aperture (16) disposed at a bottom of the first chamber (11) for communicating with the first chamber (11) and the accommodation space (15). Each of the plurality of first engaging portions (12) of the bead chain seat (1) comprises an inserting slice (121) having a dovetail shape and a first inserting hole (122) on the inserting slice (121). Preferably, each of the plurality of first engaging parts (13) of the bead chain seat (1) is formed as a tenon and provided with a support surface (131) and a guiding incline (132) opposite to the support surface (131). The accommodation space (15) is further provided with a pit (151).

The first driving assembly (2) is provided with a first driving unit (21), an elastic unit (22), and a second driving unit (23) for sequential accommodation in the first chamber (11) of the bead chain seat (1). The first driving unit (21) is provided with a first assembly end (211) for passing through the aperture (16) of the first chamber (11) to the accommodation space (15), a second assembly end (212) opposite to the first assembly end (211), and a first stop flange (213) disposed on a periphery of the first driving unit (21) for contacting the bottom of the first chamber (11) for positioning. Preferably, the first assembly end (211) of the first driving unit (21) is shaped as a cone and provided with a plurality of first convex ribs (214) spaced apart from one another at equal angular interval. The second assembly end (212) of the first driving unit (21) is provided with a receiving slot (215) which is shaped as a polygon, e.g. a hexagon. Preferably, the elastic unit (22) is a compression spring, and its center is further provided with a housing aperture (221) for correspondingly connecting the second assembly end (212) of the first driving unit (21). Moreover, one end of the second driving unit (23) is provided with an assembly pillar (231) which is shaped as a polygon, e.g. a hexagon, for passing through the housing aperture (221) of the elastic unit (22) and further inserting into the receiving slot (215) at the second assembly end (212) of the first driving unit (21); the other end of the second driving unit (23) is provided with a second stop flange (232). In such a case, the elastic unit (22) is located between the first stop flange (213) of the first driving unit (21) and the second stop flange (232) of the second driving unit (23), and two ends of the elastic unit (22) are respectively connected to the first stop flange (213) of the first driving unit (21) and the second stop flange (232) of the second driving unit (23) for positioning. A center of the assembly pillar (231) of the second driving unit (23) is provided with a shaft hole (233) which is shaped as a polygon, e.g. a rectangle.

The assembly lid (3) is provided with a basal part (31) and a joint section (32). The basal part (31) is accommodated in the first chamber (11) of the bead chain seat (1) for covering at the opening of the first chamber (11) so that the first driving assembly (2) is accommodated and limited in the first chamber (11). The basal part (31) of the assembly lid (3) has a first side surface, a second side surface corresponding to the first side surface, a plurality of guide trenches (311) on two sides of the first side surface, and a plurality of second engaging parts (312) on two sides of the second side surface. Each of the plurality of second engaging parts (312) is formed as a locking slot. The plurality of guide trenches (311) of the basal part (31) of the assembly lid (3) is corresponding to the plurality of guiding inclines (132) of the plurality of first engaging parts (13) of the bead chain seat (1) for mutually guiding the basal part (31) of the assembly lid (3) insert into the bead chain seat (1) and locate between the plurality of first engaging parts (13) and the step edge (111), so that the first side surface of the basal part (31) of the assembly lid (3) can be positioned on the step edge (111) in the first chamber (11) of the bead chain seat (1). Bottoms of the plurality of second engaging parts (312) are engaged with the plurality of support surfaces (131) of the plurality of first engaging parts (13) for positioning. The joint section (32) is disposed at a center of the second side surface of the basal part (31) of the assembly lid (3) and further provided with a through hole (321) at its center.

The braking assembly (4) is provided with two braking springs (41), a braking cylinder (42) and a driving shaft (43). The two braking springs (41) are torsion springs and sleeved on the joint section (32) of the assembly lid (3). Two terminals of each of the two braking springs (41) are bent with two legs (411). The braking cylinder (42) is provided with an inner space (421) for accommodating the two braking springs (41) and the joint section (32) of the assembly lid (3), and an opening (422) at its lateral for communicating with the inner space (421). The legs (411) of the two braking springs (41) respectively contacting two sides of the opening (422) for positioning. One end of the driving shaft (43) is integrally wrapped and injected with the braking cylinder (42). In actual production, the metal driving shaft (43) is placed on a shaping mold of the braking cylinder (42) for injecting the braking cylinder (42). The other end of the driving shaft (43) is inserted into the through hole (321) of the joint section (32) of the assembly lid (3) and the shaft hole (233) of the second driving unit (23) for connection.

The second driving assembly (5) is provided with a third driving unit (51) and a fourth driving unit (52). The third driving unit (51) is formed with a channel (511) for accommodating the braking assembly (4), a limit segment (512) longitudinally disposed on the channel (511) for contacting the legs (411) of the two braking springs (41), and a teeth stick (513) at one end opposite to an opening of the channel (511). The fourth driving unit (52) is provided with an assembling seat (521), a plurality of satellite gears (522) on a periphery of the assembling seat (521) for accommodating and engaging with the teeth stick (513) of the third driving unit (51), and a third assembly end (523) at one end opposite to the plurality of satellite gears (522).

The cover (6) is provided with a second chamber (61), a pore (62) at a central bottom of the second chamber (61) for communicating with the second chamber (61), a ring gear (63) on a wall of an opening of the second chamber (61) for engaging with outer sides of the plurality of satellite gears (522) of the fourth driving unit (52), a plurality of second engaging portions (64) at the wall of the opening of the second chamber (61), and a plurality of pins (65). The third driving unit (51) and the fourth driving unit (52) are accommodated in the second chamber (61) of the cover (6), and the third assembly end (523) of the fourth driving unit (52) is pierced out of the pore (62). Each of the plurality of second engaging portions (64) of the cover (6) is provided as an engaging slot (641) having a dovetail shape for correspondingly engaging with the inserting slice (121) of the plurality of first engaging portions (12) of the bead chain seat (1), and a second inserting hole (642) on the engaging slot (641) and corresponding to the first inserting hole (122) on the dovetail shaped inserting slice (121) of each of the plurality of first engaging portions (12). The plurality of pins (65) are respectively inserted into the plurality of first inserting holes (122) and the plurality of second inserting holes (642) so that the cover (6) and the bead chain seat (1) are firmly connected.

The bead chain disc (7) is accommodated in the accommodation space (15) and provided with a first end, a second end, a convex portion (71) at an a center of the first end for correspondingly contacting the pit (151) of the accommodation space (15), and an accommodating slot (72) at a center of the second end of the bead chain disc (7). A wall of the accommodating slot (72) is disposed with a plurality of second convex ribs (721) spaced apart from one another at equal angular interval for correspondingly contacting the plurality of first convex ribs (214) at the first assembly end (211) for positioning, so that the first assembly end (211) of the first driving unit (21) is accommodated in the accommodating slot (72) of the bead chain disc (7).

In assembly of the present invention, an automation equipment is used to assemble and position the bead chain seat (1) on a fixture, and then the automation equipment is used to sequentially assemble the first driving unit (21), the elastic unit (22), and the second driving unit (23) of the first driving assembly (2) in the first chamber (11) of the bead chain seat (1). The first assembly end (211) of the first driving unit (21) is located in the accommodation space (15) by passing through the aperture (16) at the bottom of the first chamber (11). The housing aperture (221) of the elastic unit (22) is sleeved on the second assembly end (212) of the first driving unit (21). The assembly pillar (231) of the second driving unit (23) is inserted into the housing aperture (221) of the elastic unit (22) and further inserted into the receiving slot (215) at the second assembly end (212) of the first driving unit (21). The assembly lid (3) is placed in the first chamber (11) of the bead chain seat (1).

The plurality of guiding inclines (132) of the plurality of first engaging parts (13) on the first chamber (11) of the bead chain seat (1) is used for mutually guiding the plurality of guide trenches (311) of the basal part (31) of the assembly lid (3), so that the basal part (31) is located between the plurality of first engaging parts (13) and the step edge (111) in the first chamber (11) of the bead chain seat (1) and positioned on the step edge (111), and the bottoms of the plurality of second engaging parts (312) of the basal part (31) contacts the plurality of support surfaces (131) of the plurality of first engaging parts (13) for positioning.

Furthermore, the automation equipment is used to sleeve the two braking springs (41) of the braking assembly (4) on the joint section (32) of the assembly lid (3) and insert the driving shaft (43) into the through hole (321) of the joint section (32) of the assembly lid (3) and the shaft hole (233) of the second driving unit (23) for connection. In such a case, the two braking springs (41) and the joint section (32) of the assembly lid (3) are accommodated in the inner space (421) of the braking cylinder (42) integrated with the driving shaft (43). Then, the automation equipment is used to sleeve the channel (511) of the third driving unit (51) of the second driving assembly (5) on the braking assembly (4) and sleeve the fourth driving unit (52) on the teeth stick (513) of the third driving unit (51), so inner sides of the plurality of satellite gears (522) of the fourth driving unit (52) are engaged with the teeth stick (513) of the third driving unit (51). The automation equipment is also used to sleeve the second chamber (61) of the cover (6) on the fourth driving unit (52) and the third driving unit (51), so the third assembly end (523) of the fourth driving unit (52) is pierced out of the pore (62) and the ring gear (63) on the wall of the opening of the second chamber (61) of the cover (6) is engaged with outer sides of the plurality of satellite gears (522) of the fourth driving unit (52). The dovetail shaped engaging slots (641) of the plurality of second engaging portions (64) on the second chamber (61) of the cover (6) are respectively and correspondingly engaged with the dovetail shaped inserting slices (121) of the plurality of first engaging portions (12) of the bead chain seat (1), and then the plurality of pins (65) are respectively inserted into the plurality of first inserting holes (122) on the dovetail shaped inserting slices (121) and the plurality of second inserting holes (642) on the dovetail shaped engaging slots (641) so that the cover (6) and the bead chain seat (1) are firmly connected.

After a bead chain string (8) is wound around the bead chain disc (7), the bead chain disc (7) is disposed in the accommodation space (15) of the bead chain seat (1), so the convex portion (71) at the first end of the bead chain disc (7) correspondingly contacts the pit (151) of the accommodation space (15), and the accommodating slot (72) at the second end of the bead chain disc (7) receives the first assembly end (211) of the first driving unit (21) located in the accommodation space (15) the for connection. The plurality of second convex ribs (721) of the accommodating slot (72) is correspondingly engaged with the plurality of first convex ribs (214) at the first assembly end (211) for positioning. In such a case, the plurality of first engaging parts (13) of the bead chain seat (1) is engaged with the plurality of second engaging parts (312) of the assembly lid (3) to position the first driving assembly (2) on the first chamber (11) of the bead chain seat (1). Additionally, the plurality of second engaging portions (64) of the cover (6) is assembled to the plurality of first engaging portions (12) of the bead chain seat (1) by engagement for positioning the braking assembly (4) and the second driving assembly (5).

Accordingly, the curtain controller assembly structure of the present invention does not need screws to lock, so it saves the cost of using a screw for locking. Furthermore, the present invention can be assembled automatically due to the single assembly direction so as to achieve effects, e.g. automated production, increased production capacity, reduced labor costs, and stable product quality.

In use of the curtain controller assembly structure of the present invention, the bead chain string (8) is pulled so that the plurality of second convex ribs (721) of the accommodating slot (72) of the bead chain disc (7) is correspondingly engaged with the plurality of first convex ribs (214) at the first assembly end (211) of the first driving unit (21) to drive the first driving unit (21) to rotate. The first driving unit (21) drives the second driving unit (23) which is sleeved with the receiving slot (215) to rotate, and the second driving unit (23) further drives the driving shaft (43) which is sleeved with the shaft hole (233) to rotate. When the braking cylinder (42) is driven to rotate by the driving shaft (43), one side of the opening (422) of the braking cylinder (42) is pressed against the legs (411) of one terminal of the two braking springs (41) to release the joint section (32) of the assembly lid (3) from the two braking springs (41), so that the two braking springs (41) and the braking cylinder (42) rotate together. When the braking springs (41) is rotated, the legs (411) of the braking springs (41) is pushed against the limit segment (512) of the third driving unit (51) to drive the third driving unit (51) to rotate together. The rotation of the third driving unit (51) also drives the plurality of satellite gears (522) of the fourth driving unit (52) to move through the teeth stick (513) engaging with the fourth driving unit (52). The satellite gears (522) are also guided to rotate by the ring gear (63) so that the assembling seat (521) is rotated at a variable speed. In this way, the present invention achieves a labor saving effect by rolling a curtain on a roller rod connected with the third assembly end (523) on the assembling seat (521). When the satellite gears (522) of the fourth driving unit (52) is guided to rotate by the ring gear (63) of the cover (6), a counter torque is applied on the cover (6) by the satellite gears (522). Due to the design of the dovetail shaped engaging slots (641) of the engaging portions (64) of the cover (6) engaging with the dovetail shaped inserting slices (121) of the first engaging portions (12) of the bead chain seat (1), the cover (6) is not easily detached from the bead chain seat (1) when the cover (6) is subject to the counter torque.

If a child is accidentally wrapped around their necks by the bead chain string (8) when playing the bead chain string (8) and exerts a pulling force on the bead chain string (8), the bead chain disc (7) can be detached from the bead chain seat (1) by a slope guidance of the accommodating slot (72) of the bead chain disc (7) and the first assembly end (211) of the first driving unit (21) to push the first driving unit (21) for further compressing the adjacent elastic unit (22) and making the first driving unit (21) move towards the second driving unit (23). After the accommodating slot (72) at the second end of the bead chain disc (7) is completely disengaged from the first assembly end (211) of the first driving unit (21), the convex portion (71) at the first end of the bead chain disc (7) can be pulled out of the pit (151) of the accommodation space (15). In such a case, the bead chain disc (7) can be separated from the bead chain seat (1), the first driving unit (21), and the bead chain string (8) so as to unwind the bead chain string (8) on the children's necks and prevent children from choke.

According to the above description, in comparison with the traditional technique, a curtain controller assembly structure according to the present invention has the advantages as following:

1. The present invention does not need screws to lock, so it saves the cost of using screws. Furthermore, the present invention can be assembled automatically due to the single assembly direction so as to achieve effects, e.g. automated production, increased production capacity, reduced labor costs, and stable product quality.

2. Due to the design of engagement of the dovetail shaped engaging slots of the engaging portions of the cover with the dovetail shaped inserting slices of the first engaging portions of the bead chain seat, the cover is not easily detached from the bead chain seat when the cover is subject to the counter torque.

3. Due the engagement of the first engaging parts of the bead chain seat with the second engaging parts of the basal part, when the braking assembly is rotated, the assembly lid can be secured on the bead chain seat without rotation.

4. The metal driving shaft of the present invention is placed on a shaping mold of the braking cylinder for injecting the braking cylinder, so the driving shaft is integrally wrapped and injected with the braking cylinder. In such a way, the braking cylinder does not need a preset aperture larger than a diameter of the driving shaft, which prevents unsmooth rotation and idle rotation due to the gap between the braking cylinder and driving shaft being enlarged by an abrasion of the driving shaft for a period of time.

What is claimed is:

1. A curtain controller assembly structure, comprising:
a bead chain seat having a first chamber and a plurality of first engaging parts on a wall of the first chamber, wherein the first chamber is provided with a step edge on the wall thereof and adjacent to the plurality of first engaging parts; and
an assembly lid having a basal part accommodated in the first chamber of the bead chain seat and located between the plurality of first engaging parts and the step edge, wherein the basal part has a first side surface for contacting the step edge of the first chamber, a second side surface, and a plurality of second engaging parts disposed on a lateral thereof for respectively engaging with the plurality of first engaging parts of the first chamber for positioning.

2. The curtain controller assembly structure as claimed in claim 1, wherein each of the plurality of first engaging parts of the bead chain seat is formed as a tenon, and each of the plurality of second engaging parts of the assembly lid is formed as a locking slot disposed at the lateral of the second side surface of the basal part for engaging with each of the plurality of first engaging parts for positioning.

3. The curtain controller assembly structure as claimed in claim 2, wherein each of the plurality of first engaging parts of the bead chain seat is provided with a support surface for contacting bottoms of the plurality of second engaging parts of the basal part for positioning and a guiding incline opposite to the support surface, and the lateral of the first side surface of the basal part of the assembly lid is provided with a plurality of guide trenches corresponding to the plurality of first engaging parts for mutually guiding the basal part of the assembly lid insert into the bead chain seat and locate between the plurality of first engaging parts and the step edge.

4. The curtain controller assembly structure as claimed in claim 1, wherein the bead chain seat is provided with a plurality of first engaging portions at an opening of the first chamber and connected with a cover having a second chamber for correspondingly connecting the opening of the first chamber of the bead chain seat and a plurality of second engaging portions on a wall of an opening of the second chamber for correspondingly engaging with the plurality of first engaging portions of the bead chain seat.

5. The curtain controller assembly structure as claimed in claim 4, wherein each of the plurality of first engaging portions of the bead chain seat is formed as an inserting slice having a dovetail shape, and each of the plurality of second engaging portions of the cover is formed as an engaging slot having a dovetail shape for correspondingly engaging with the inserting slice of the bead chain seat.

6. The curtain controller assembly structure as claimed in claim 4, wherein each of the plurality of first engaging portions of the bead chain seat and each of the plurality of second engaging portions of the cover are respectively provided with a first inserting hole and a second inserting hole corresponding to the first inserting hole for an insertion of a pin.

7. The curtain controller assembly structure as claimed in claim 1, furthering comprising a braking assembly having a braking cylinder and a driving shaft having one end integrally wrapped and injected with the braking cylinder, wherein the braking cylinder is provided with an inner space, and a center of the second side surface of the basal part of the assembly lid is provided with a joint section for inserting in the inner space of the braking cylinder and having a through hole at a center thereof for an insertion of the other end of the driving shaft.
